(19) United States
(12) Patent Application Publication
(10) Pub. No.: US 2005/0029767 A1
(43) Pub. Date: Feb. 10, 2005

(54) Skateboard with illumination device

(76) Inventor: Jen-Show Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/632,896

(22) Filed: Aug. 4, 2003

(51) Int. Cl. B62M 1/00

(52) U.S. Cl. 280/87.042

(57) ABSTRACT

A skateboard includes a board portion and front wheels and rear wheels are respectively connected to an underside of the board portion by two shafts. Each of the shafts has two disks and each disk has a conductive ring. Each wheel includes a magnetic ring and a coil encloses the magnetic ring. A conductive circular casing is mounted to the coil and has a plurality of LEDs. Two legs extend from each of the LEDs and are electrically connected to the conductive ring on the disk. The LEDs illuminate while the wheels are rotated. A plurality of LEDs are embedded in a periphery of the board portion and wires extending from the conductive rings are connected to the LEDs via grooves defined in the board portion.

### FIELD OF THE INVENTION

The present invention relates to a skateboard having LEDs embedded in a periphery of the board portion and illuminative wheels each have a generator received therein so as to provide electric power to the LEDs and the wheels.

### BACKGROUND OF THE INVENTION

A conventional skateboard is disclosed in U.S. Pat. No. 4,997,196 and shown in FIGS. 9 and 10. The illuminated skateboard as disclosed generally includes a board portion 10 with a plurality of LEDs 40 connected in a periphery of the board portion 10 and two pairs of wheels 70 connected to front and rear trucks. A microcontroller 80 powered by battery 82 is connected to an underside of the board portion 10 and protrudes from the board portion 10. There are plenty of wires 81 extended from the microcontroller to the LEDs 40 so as to provide electric power to the LEDs 40. The battery set has to be renewed with new batteries so as to maintain the function or the LEDs 40 and the battery set increases the weight of the skateboard.

The present invention intends to provide a skateboard that has an electricity generator received in each wheel and the wires can be received in grooves in the board portion so that the skateboard does not have battery set and can be made as slim as possible.

### SUMMARY OF THE INVENTION

In accordance with one aspect of the present invention, there is provided a skateboard comprising a board portion and a front shaft and a rear shaft are respectively connected to an underside of the board portion. Each of the front shaft and the rear shaft includes two disks and each disk includes a conductive ring. Two wheels are connected to each of the front shaft and the rear shaft and each wheel includes a central tube on which a bearing and a magnetic ring are mounted thereto. The central tubes are connected to the front shaft and the rear shaft.

A conductive circular casing has a plurality of LEDs connected to an outer periphery thereof and an inner ring is located in the circular casing. A coil is mounted to the inner ring and rotatable relative to the magnetic ring so as to generate electricity provided to the LEDs. Two legs extending from each of the LEDs are electrically connected to the conductive ring on the disk.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the skateboard of the present invention;

FIG. 2 is an exploded view to show the skateboard of the present invention;

FIG. 3 is a top view to show the skateboard of the present invention;

FIG. 3-1 is a side view to show the skateboard of the present invention;

FIG. 4 shows a cross sectional view of the board portion of the skateboard of the present invention;

FIG. 5 shows the LEDs light up when the skateboard of the present invention is moving;

FIG. 6 is a perspective view to show the wheels of the skateboard of the present invention;

FIG. 7 is an exploded view to show the structure of the skateboard of the present invention;

FIG. 8 is an exploded view to show illumination unit in each wheel of the skateboard of the present invention;

FIG. 9 is a bottom view to show the skateboard disclosed in U.S. Pat. No. 4,997,196, and

FIG. 10 shows the circuit and wires in the skateboard disclosed in U.S. Pat. No. 4,997,196.

### DETAILED DESCRIPTION OF THE PREFERRED EMBODIMENT

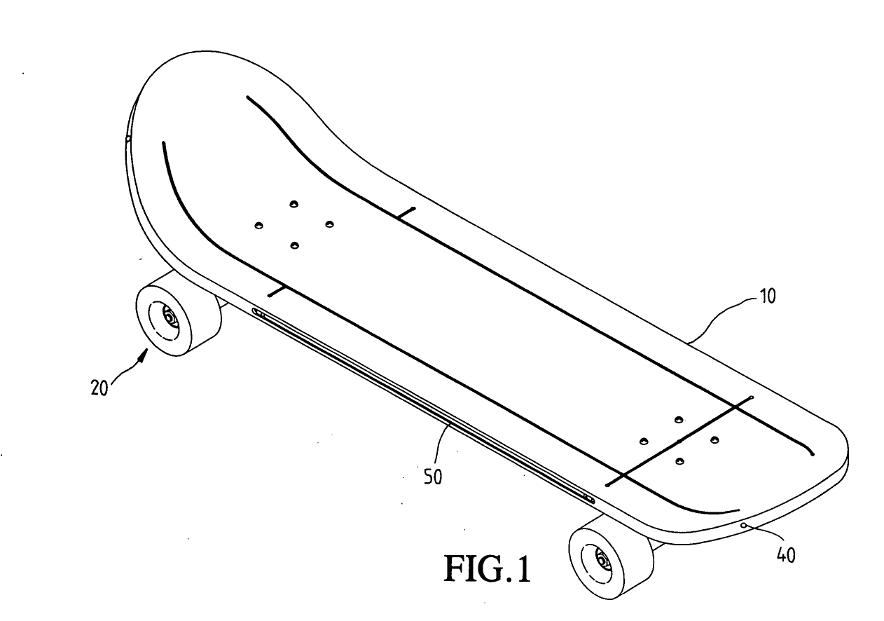

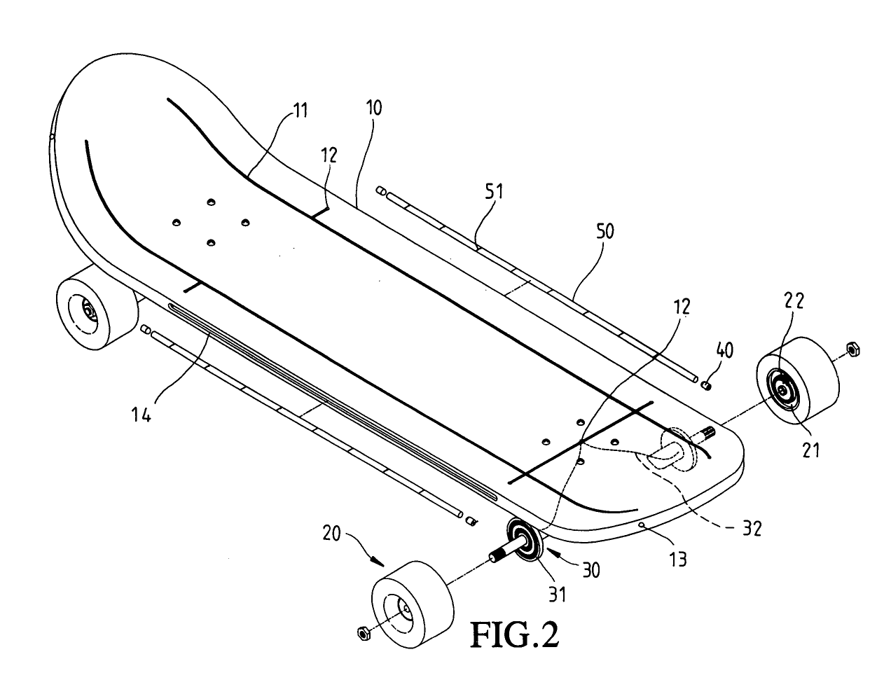

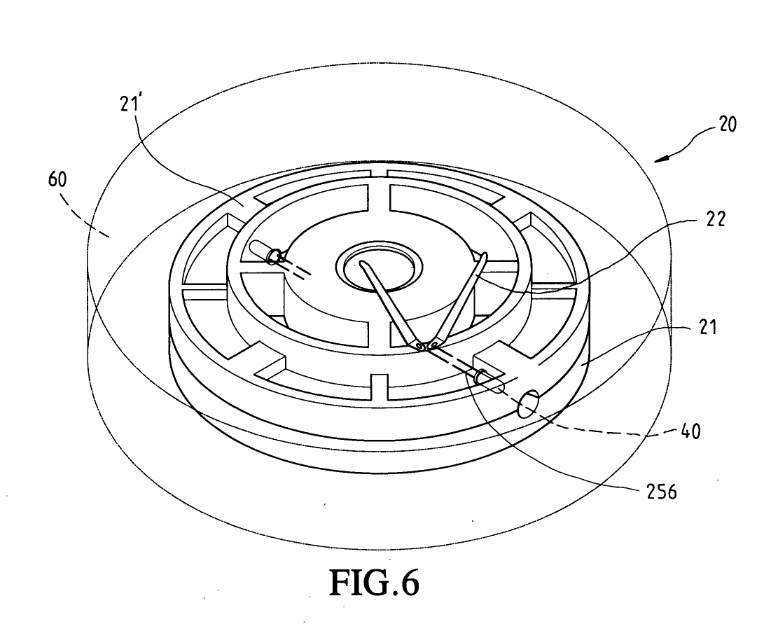

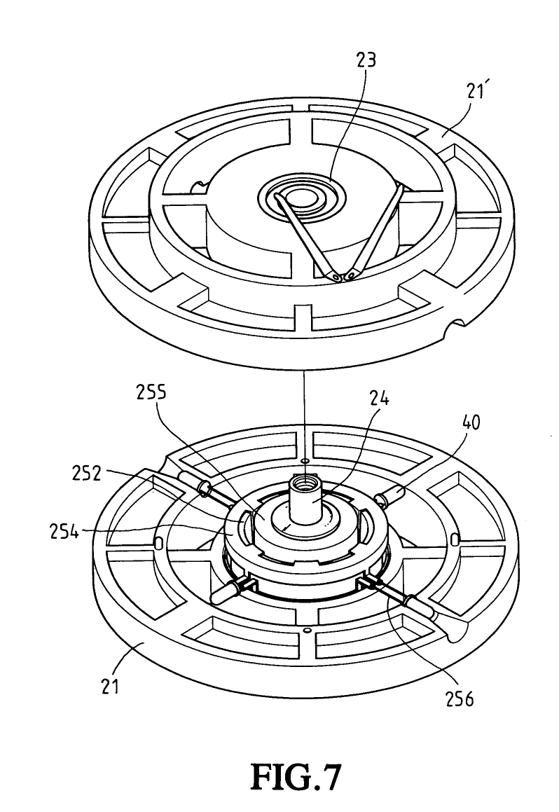

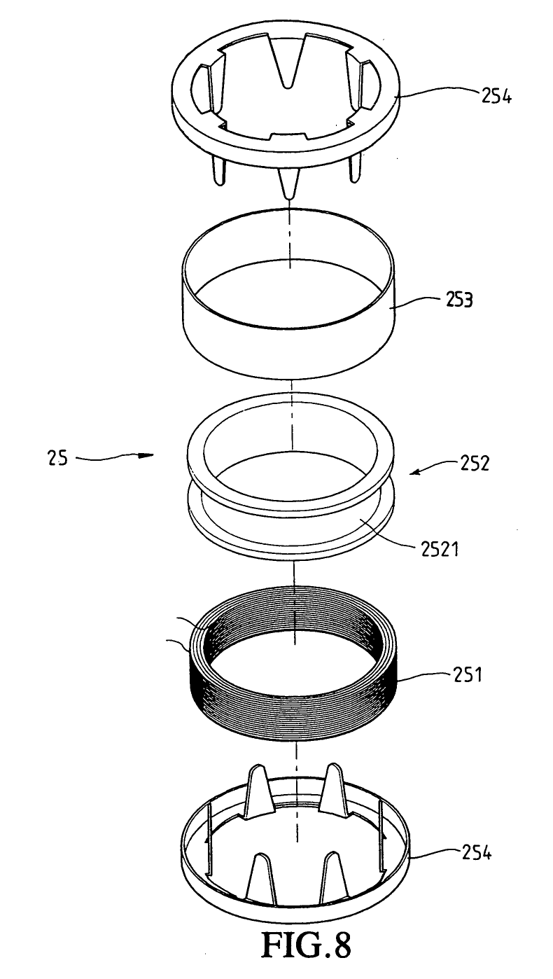

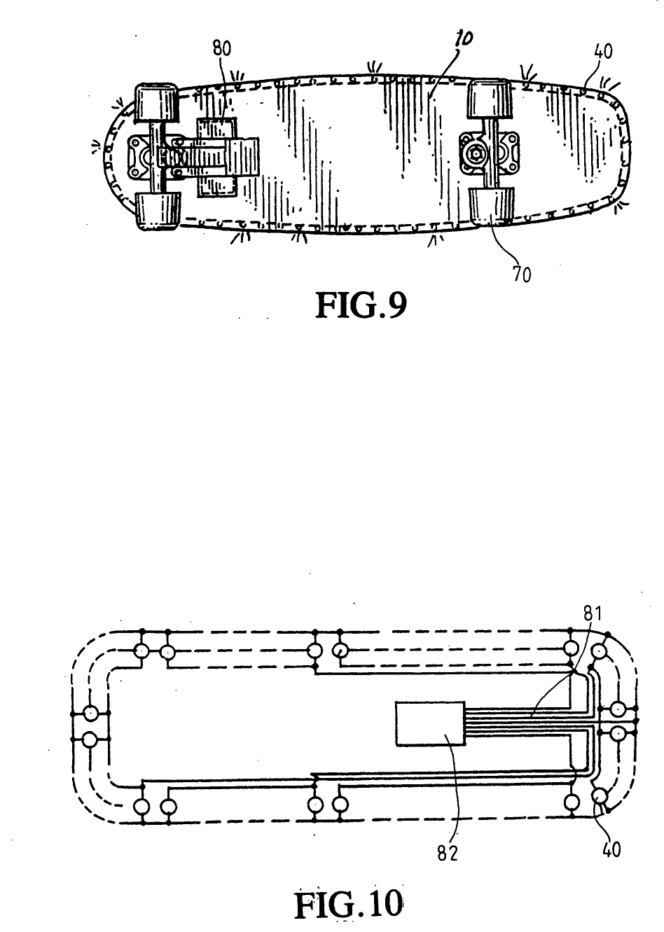

Referring to FIGS. 1, 2, 6, 7 and 8, the skateboard of the present invention comprises a board portion 10 and a front shaft and a rear shaft are respectively connected to an underside of the board portion 10. Each of the front shaft and the rear shaft includes two disks 30 and each disk 30 includes a conductive ring 31. Each of the front shaft and the rear shaft has two wheels 20 connected thereto. Each wheel 20 is composed of two circular members 21, 21′ and the circular member 21 has a central tube 24 on which a magnetic ring 255 is mounted thereto. The other circular member 21′ has a bearing 23 which is mounted to the central tube 24. The body 60 of the wheels 20 encloses to the combined circular members 21, 21′. The wheels 20 are disposed to the front shaft and the rear shaft by connecting the central tubes 24 of the two wheels 20 to the two respective shafts. Each wheel 20 includes a illumination unit 25 which includes a conductive circular casing composed of two halves 254 and a plurality of LEDs 40 are connected to an outer periphery of the conductive circular casing. An inner ring 252 is located in the circular casing 254. The inner ring 252 has a groove 2521 defined in an outer periphery thereof and a coil 251 is engaged with the groove 2521. An isolation ring 253 is engaged in an inner periphery of the inner ring 252. The coil 251 is rotatable relative to the magnetic ring 255 while the wheels 20 are rolling and the relative movement between the coil 251 and the magnetic ring 255 generates electricity. Two legs 256 extending from each of the LEDs 40 are electrically connected to the the conductive ring 31 on the disk 30.

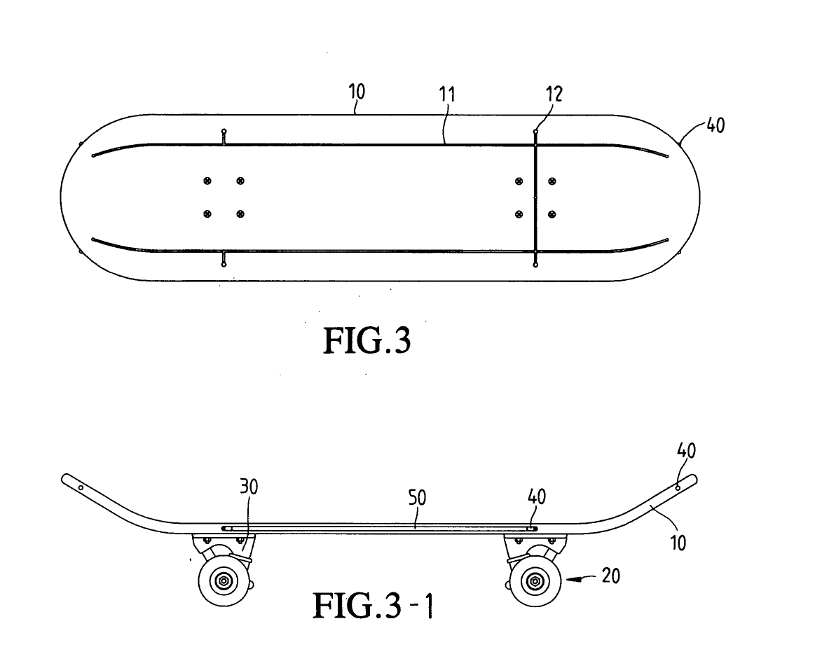

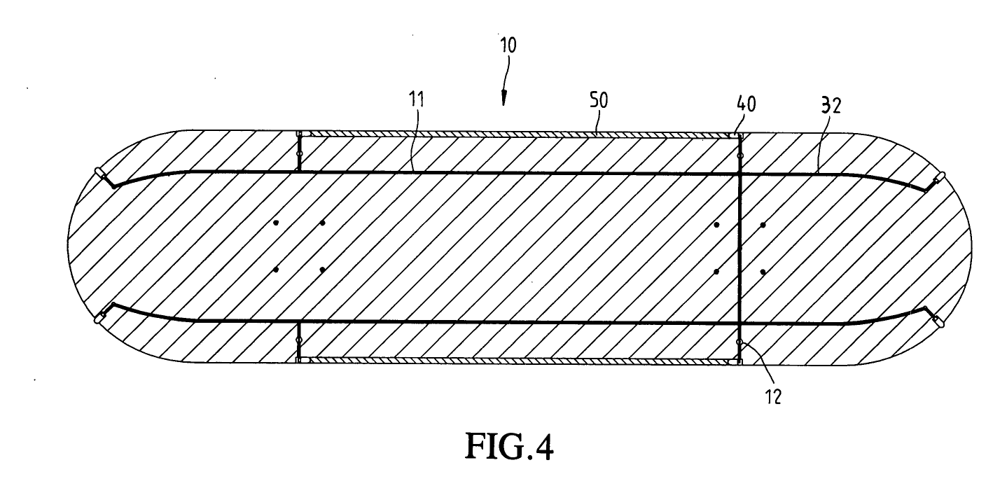

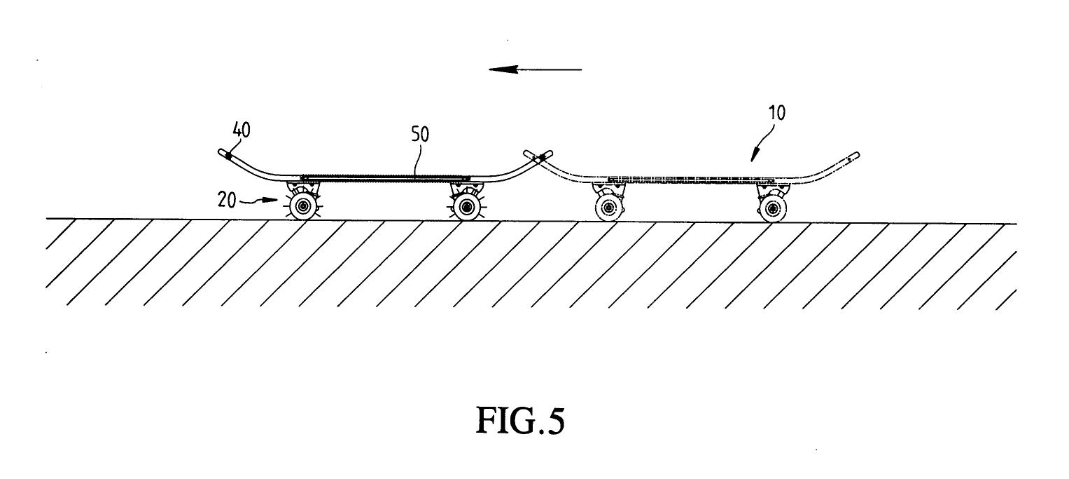

Referring to FIGS. 3, 3-1, 4 and 5, the board portion 10 includes a plurality of recesses 13 defined in a periphery thereof and each recess 13 has an LED 40 received therein. A plurality of grooves 11 are defined in a top of the board portion 10 and the recesses 13 each communicate with the grooves 11. Wires 32 extending from the conductive rings 31 go thorough holes 12 communicating with the grooves 11 and are received in the grooves 11 so as to be connected to the LEDs 40 in the recesses 13. An non-skid surface (not shown) is coated on the top of the board portion 10.

Two illumination tubes 50 are engaged in the periphery of the board portion 10 and a plurality of holes 51 are defined through each of the illumination tubes 50 so that the light from the LEDs 40 can be guided in the illumination tubes 50.

The skateboard needs no batteries to activate the LEDs and there is no microcontroller and battery protruding from the underside of the skateboard. Therefore, the players can grind ramps by the underside of the skateboard without worry of damage of the microcontroller and battery.

While we have shown and described the embodiment in accordance with the present invention, it should be clear to those skilled in the art that further embodiments may be made without departing from the scope of the present invention.

1. A skateboard comprising:
a board portion and a front shaft and a rear shaft respectively connected to an underside of the board portion, each of the front shaft and the rear shaft including two disks and each disk including a conductive ring, each of the front shaft and the rear shaft having two wheels connected thereto, each wheel including a central tube on which a bearing and a magnetic ring are mounted thereto, the wheels disposed to the front shaft and the rear shaft by the central tubes, a conductive circular casing having a plurality of LEDs connected to an outer periphery thereof and an inner ring located in the circular casing, a coil mounted to the inner ring and being rotatable relative to the magnetic ring, two legs extending from each of the LEDs and electrically connected to the conductive ring on the disk.

2. The skateboard as claimed in claim 1, wherein the board portion includes a plurality of recesses defined in a periphery thereof and each recess has an LED received therein, a plurality of grooves defined in the board portion and wires extending from the conductive rings being received in the grooves and connected to the LEDs in the recesses.

3. The skateboard as claimed in claim 1, wherein at least one illumination tube is engaged in the periphery of the board portion and a plurality of holes are defined through the at least one illumination tube.
